(19) United States
(12) Patent Application Publication
(10) Pub. No.: US 2025/0119900 A1
(43) Pub. Date: Apr. 10, 2025

(54) METHODS AND DEVICES FOR REPORTING IN-DEVICE COEXISTENCE INTERFERENCE

(71) Applicant: ZTE Corporation, Shenzhen (CN)

(72) Inventors: Wenting LI, Shenzhen (CN); Jing LIU, Shenzhen (CN)

(73) Assignee: ZTE Corporation, Shenzhen (CN)

(21) Appl. No.: 18/981,898

(22) Filed: Dec. 16, 2024

Related U.S. Application Data
(63) Continuation of application No. PCT/CN2023/074048, filed on Jan. 31, 2023.

(51) Int. Cl. H04W 72/12; H04W 72/0453; H04W 88/06

(52) U.S. Cl. CPC H04W 72/1215; H04W 72/0453; H04W 88/06

(57) ABSTRACT

The present disclosure describes methods, system, and devices for reporting in-device coexistence (IDC) interference. One method includes receiving, by a first communication node, a first message from a second communication node, the first message comprising a second list of candidate frequency for the second communication node; sending, by the first communication node, a second message to a user equipment (UE); receiving, by the first communication node, a third message from the UE, the third message comprising an in-device coexistence (IDC) report corresponding to a first list of candidate frequency for the first communication node or a second list of candidate frequency for the second communication node; and sending, by the first communication node, a fourth message to the second communication node, the fourth message comprising at least a portion of the IDC report corresponding to the second list of candidate frequency for the second communication node.

### TECHNICAL FIELD

The present disclosure is directed generally to wireless communications. Particularly, the present disclosure relates to methods and devices for reporting in-device coexistence (IDC) interference.

### BACKGROUND

Wireless communication technologies are moving the world toward an increasingly connected and networked society. An emerging trend in mobile communications is the parallel usage of multiple radio technologies in user equipments (UEs), including but not limited to, mobile devices, tablets and other communications modules. In order to support this parallel operation, the devices are equipped with more than one radio transceivers, which are located extremely close to each other. When one or more radio transceivers operates, one or more nearby transceivers may interfere from each other, resulting in in-device coexistence (IDC) interference. Under multiple radio access technologies (Multi-RAT) duel connectivity (MR-DC) structure, there may be some issues/problems associated with IDC reporting, for example, a poor performance of the coordination between a master node (MN) and a secondary node (SN).

The present disclosure describes various embodiments for reporting IDC interference, addressing at least one of issues/problems discussed above, providing improvement in the technology field of wireless communication and increasing its efficiency and performance.

### SUMMARY

This document relates to methods, systems, and devices for wireless communication, and more specifically, for reporting IDC interference. The various embodiments in the present disclosure may be beneficial to improve IDC reporting, to decrease the IDC interference, increase resource utilization efficiency, and to boost performance of the wireless communication.

In one embodiment, the present disclosure describes a method for wireless communication. The method includes receiving, by a first communication node, a first message from a second communication node, the first message comprising a second list of candidate frequency for the second communication node; sending, by the first communication node, a second message to a user equipment (UE); receiving, by the first communication node, a third message from the UE, the third message comprising an in-device coexistence (IDC) report corresponding to a first list of candidate frequency for the first communication node or a second list of candidate frequency for the second communication node; and sending, by the first communication node, a fourth message to the second communication node, the fourth message comprising at least a portion of the IDC report corresponding to the second list of candidate frequency for the second communication node.

In another embodiment, the present disclosure describes a method for wireless communication. The method includes receiving, by a user equipment (UE), a second message from a first communication node, wherein the second message is sent by the first communication node in response to receiving a first message from a second communication node, the first message comprising a second list of candidate frequency for the second communication node; and sending, by the UE, a third message to the first communication node, the third message comprising an in-device coexistence (IDC) report corresponding to a first list of candidate frequency for the first communication node or the second list of candidate frequency for the second communication node, wherein the first communication node is configured to send a fourth message to the second communication node, the fourth message comprising at least a portion of the IDC report corresponding to the second list of candidate frequency for the second communication node.

In another embodiment, the present disclosure describes a method for wireless communication. The method includes receiving, by a first communication node, user equipment (UE) assistance information from a UE, the UE assistance information comprising an in-device coexistence (IDC) report corresponds to at least one IDC combination under MR-DC; sending, by the first communication node, a request to a second communication node, the request comprising first assistance information of the first communication node; and receiving, by the first communication node, a request acknowledge from the second communication node.

In another embodiment, the present disclosure describes a method for wireless communication. The method includes sending, by a user equipment (UE), UE assistance information to a first communication node, the UE assistance information comprising an in-device coexistence (IDC) report corresponds to at least one IDC combination under MR-DC; and receiving, by the UE, a radio resource control (RRC) reconfiguration message from the first communication node.

In some other embodiments, an apparatus for wireless communication may include a memory storing instructions and a processing circuitry in communication with the memory. When the processing circuitry executes the instructions, the processing circuitry is configured to carry out any of the above methods.

In some other embodiments, a device for wireless communication may include a memory storing instructions and a processing circuitry in communication with the memory. When the processing circuitry executes the instructions, the processing circuitry is configured to carry out any of the above methods.

In some other embodiments, a computer-readable medium comprising instructions which, when executed by a computer, cause the computer to carry out any of the above methods.

The above and other aspects and their implementations are described in greater detail in the drawings, the descriptions, and the claims.

### BRIEF DESCRIPTION OF THE DRAWINGS

FIG. 1A shows an example of a wireless communication system include one wireless network node and one or more user equipment.

FIG. 1B shows a schematic diagram of in-device coexistence interference within a same UE.

FIG. 2 shows an example of a network node.

FIG. 3 shows an example of a user equipment.

FIG. 4A shows a flow diagram of a method for wireless communication.

FIG. 4B shows a flow diagram of another method for wireless communication.

FIG. 5A shows a flow diagram of another method for wireless communication.

FIG. 5B shows a flow diagram of another method for wireless communication.

FIG. 6A shows a schematic diagram of a non-limiting embodiment for wireless communication.

FIG. 6B shows a schematic diagram of another non-limiting embodiment for wireless communication.

FIG. 6C shows a schematic diagram of another non-limiting embodiment for wireless communication.

FIG. 7A shows a schematic diagram of a non-limiting embodiment for wireless communication.

FIG. 7B shows a schematic diagram of another non-limiting embodiment for wireless communication.

FIG. 7C shows a schematic diagram of another non-limiting embodiment for wireless communication.

FIG. 8A shows a schematic diagram of a non-limiting embodiment for wireless communication.

FIG. 8B shows a schematic diagram of another non-limiting embodiment for wireless communication.

FIG. 9 shows a schematic diagram of another non-limiting embodiment for wireless communication.

FIG. 10 shows a schematic diagram of another non-limiting embodiment for wireless communication.

FIG. 11 shows a schematic diagram of another non-limiting embodiment for wireless communication.

FIG. 12 shows a schematic diagram of another non-limiting embodiment for wireless communication.

FIG. 13 shows a schematic diagram of another non-limiting embodiment for wireless communication.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B, or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

The present disclosure describes methods and devices for reporting in-device coexistence (IDC) interference.

Next generation (NG), or 5th generation (5G), wireless communication may provide a range of capabilities from downloading with fast speeds to support real-time low-latency communication. New generation (NG) mobile communication system are moving the world toward an increasingly connected and networked society.

An emerging trend in mobile communications is the parallel usage of multiple radio technologies in user equipments (UEs), including but not limited to, mobile devices, tablets and other communications modules. In order to support this parallel operation, the devices are equipped with more than one radio transceivers, which are located extremely close to each other. When one or more radio transceivers operates, one or more nearby transceivers may interfere from each other, resulting in in-device coexistence (IDC) interference.

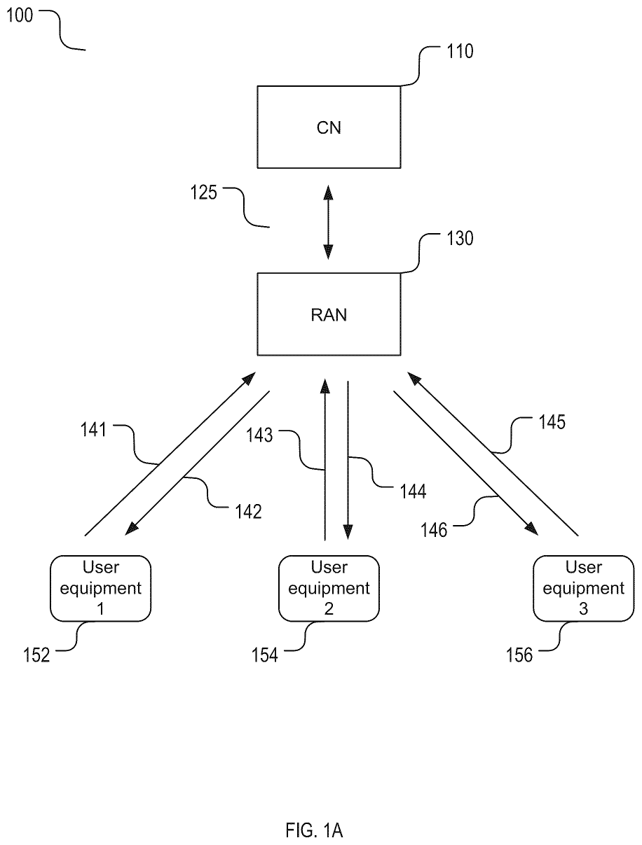

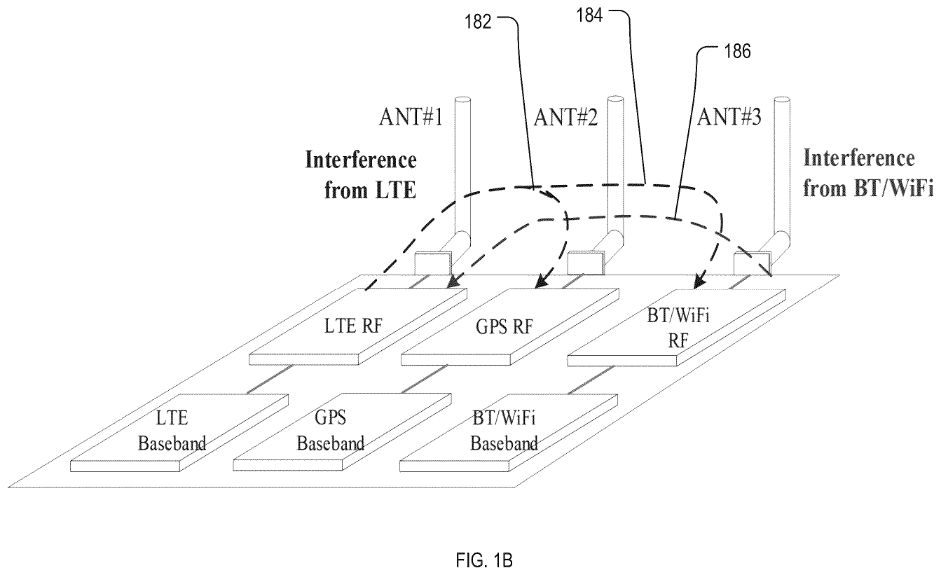

As shown in FIG. 1B, due to extreme proximity of multiple radio transceivers within a same UE, the transmit power of one transmitter may be much higher than the received power level of another receiver. For a non-limiting example, the UE may include a first transceiver for a long term evolution (LTE), a second transceiver for GPS, a third transceiver for WiFi, and/or a fourth transceiver for bluetooth (BT). There may be IDC interference between any combination of the above described transceiver. For example, when the first transceiver is transmitting or receiving on one frequency carrier or a combination of more than one frequency carriers, there may be a first interference 182 to the second transceiver, and/or a second interference 184 to the third transceiver; and/or when the third transceiver is transmitting or receiving on one frequency carrier or a combination of more than one frequency carriers, there may be a third interference 186 to the second transceiver, and/or a second interference.

In some implementations, to solve these issue, IDC related mechanism may be introduced. For example, in the LTE, the IDC may be triggered for both the serving frequency and non-serving frequency when the network indicates to report IDC assistance information. Furthermore, both the current experiencing IDC problems and the potential IDC problems on the secondary frequency and the non-serving frequency (for which a measurement object is configured) may be reported. In some implementations, a similar IDC scheme may be introduced for the new ratio (NR) and/or evolved universal terrestrial radio access (EUTRA) and NR duel connectivity (EN-DC) case.

In some implementations, one IDC solution in NR may be based on the carriers, leading to one issue/problem that the affected frequencies cannot be adequately indicated via the NR frequency division multiplexing (FDM) solution. In some other implementations, the FDM enhancement may be based on the frequency range. In some implementations, besides the enhancement on the UAI reporting, there may be some issues/problems associated with IDC in configuring the multiple radio access technologies (Multi-RAT) duel connectivity (MR-DC), for example. how to configure the IDC reporting with FDM enhancement under the MR-DC structure, and/or how the master node (MN) and the secondary node (SN) coordinate with each other.

In some implementations for NR standalone (SA) IDC, the network may configure a user equipment (UE) to report the IDC with the below Asn.1 coding in the “Otherconfig” element of the RRCReconfiguration message.

IDC-AssistanceConfig-r16 ::= SEQUENCE {
candidateServingFreqListNR-r16 CandidateServingFreqListNR-r16 OPTIONAL, -- Need M ...}
CandidateServingFreqListNR-r16 ::= SEQUENCE (SIZE (1..maxFreqIDC-r16)) OF ARFCN-ValueNR

In the above, candidateServingFreqListNR may indicate for each candidate NR serving cells, the center frequency around which UE is requested to report IDC issues.

In some implementations, when the IDC is triggered, the UE may report the IDC assistance information as below.

```
IDC-Assistance-r16 ::= SEQUENCE {
affectedCarrierFreqList-r16 AffectedCarrierFreqList-r16 OPTIONAL,
affectedCarrierFreqCombList-r16 AffectedCarrierFreqCombList-r16 OPTIONAL,
    ...
}
AffectedCarrierFreqList-r16 ::= SEQUENCE (SIZE (1..maxFreqIDC-r16)) OF AffectedCarrierFreq-r16
AffectedCarrierFreq-r16 ::= SEQUENCE {
    carrierFreq-r16 ARFCN-ValueNR,
    interferenceDirection-r16 ENUMERATED {nr, other, both, spare}
}
AffectedCarrierFreqCombList-r16 ::= SEQUENCE (SIZE (1..maxCombIDC-r16)) OF AffectedCarrierFreqComb-r16
AffectedCarrierFreqComb-r16 ::= SEQUENCE {
    affectedCarrierFreqComb-r16 SEQUENCE (SIZE (2..maxNrofServingCells)) OF ARFCN-ValueNR OPTIONAL,
    victimSystemType-r16 VictimSystemType-r16
}
VictimSystemType-r16 ::= SEQUENCE {
    gps-r16 ENUMERATED { true} OPTIONAL,
    glonass-r16 ENUMERATED { true } OPTIONAL,
    bds-r16 ENUMERATED { true} OPTIONAL,
    galileo-r16 ENUMERATED { true } OPTIONAL,
    navIC-r16 ENUMERATED { true} OPTIONAL,
    wlan-r16 ENUMERATED { true} OPTIONAL,
    bluetooth-r16 ENUMERATED { true } OPTIONAL,
    ...
}
```

In some implementations, for the EN-DC, the IDC interference that caused by the simultaneous MN and SN transmission may be introduced; and the network may configure a candidate NR frequency list for the NR side of the EN-DC in the “Otherconfig” element of the RRCReconfiguration message as below.

```
[[ idc-Indication-MRDC-r15 CHOICE{
        release NULL,
        setup CandidateServingFreqListNR-r15 }OPTIONAL -- Cond idc-Ind ]]}
```

In some implementations, to configure this candidate frequency list, some Inter-node coordination is needed. For example, the SN may provide the frequencies of candidate serving cells to the MN, and the MN may include it in the other config together with the MN candidate frequencies.
CandidateServingFreqListNR::=SEQUENCE (SIZE (1 . . . maxFreqIDC-MRDC)) OF ARFCN-ValueNR

In the above, candidateServingFreqListNR may indicates frequencies of candidate serving cells for In-Device Co-existence Indication.

In some implementations, the UE may report the MR-DC IDC interference to the network; and when the MN receives such kind of assistance information, the MN further indicates the MR-DC related IDC interference information to the SN.

```
mrdc-AssistanceInfo MRDC-AssistanceInfo OPTIONAL,
MRDC-AssistanceInfo ::= SEQUENCE {
    affectedCarrierFreqCombInfoListMRDC SEQUENCE (SIZE (1..maxNrofCombIDC)) OF
AffectedCarrierFreqCombInfoMRDC,
    ...}
AffectedCarrierFreqCombInfoMRDC ::= SEQUENCE {
    victimSystemType VictimSystemType,
    interferenceDirectionMRDC ENUMERATED {eutra-nr, nr, other, utra-nr-other, nr-other, spare3, spare2, spare1},
    affectedCarrierFreqCombMRDC SEQUENCE  {
        affectedCarrierFreqCombEUTRA AffectedCarrierFreqCombEUTRA OPTIONAL,
        affectedCarrierFreqCombNR AffectedCarrierFreqCombNR
    } OPTIONAL,
VictimSystemType ::= SEQUENCE {
    gps ENUMERATED { true} OPTIONAL,
    glonass ENUMERATED { true} OPTIONAL,
    bds ENUMERATED { true} OPTIONAL,
    galileo ENUMERATED { true} OPTIONAL,
    wlan ENUMERATED { true} OPTIONAL,
    bluetooth ENUMERATED { true} OPTIONAL}
AffectedCarrierFreqCombEUTRA ::= SEQUENCE (SIZE (1..maxNrofServingCellsEUTRA)) OF ARFCN-ValueEUTRA
AffectedCarrierFreqCombNR ::= SEQUENCE (SIZE (1..maxNrofServingCells)) OF ARFCN-ValueNR
```

In the above, mrdc-AssistanceInfo may contains the IDC assistance information for MR-DC reported by the UE.

In some implementations, for the IDC FDM enhancement, the UE would report the more finer granularity of frequency ranges to the network. There may be some issues/problems associated with how to coordinate the assistance information among the MN and SN.

FIG. 1A shows a wireless communication system 100 including a core network (CN) 110, a radio access network (RAN) 130, and one or more wireless communication device (user equipment (UE)) (152, 154, and 156). The RAN 130 may include a wireless network base station, or a NG radio access network (NG-RAN) base station or node, which may include a nodeB (NB, e.g., a gNB) in a mobile telecommunications context. The UE may be called as wireless communication device or wireless communication terminal. In one implementation, the core network 110 may include a 5G core network (5GC), and the interface 125 may include a new generation (NG) interface.

Referring to FIG. 1A, a first UE 152 may wirelessly receive one or more downlink communication 142 from the RAN 130 and wirelessly send one or more uplink communication 141 to the RAN 130. Likewise, a second UE 154 may wirelessly receive downlink communication 144 from the RAN 130 and wirelessly send uplink communication 143 to the RAN 130; and a third UE 156 may wirelessly receive downlink communication 146 from the RAN 130 and wirelessly send uplink communication 145 to the RAN 130. For example but not limited to, a downlink communication may include a physical downlink shared channel (PDSCH) or a physical downlink control channel (PDCCH), and a uplink communication may include a physical uplink shared channel (PUSCH) or a physical uplink control channel (PUCCH).

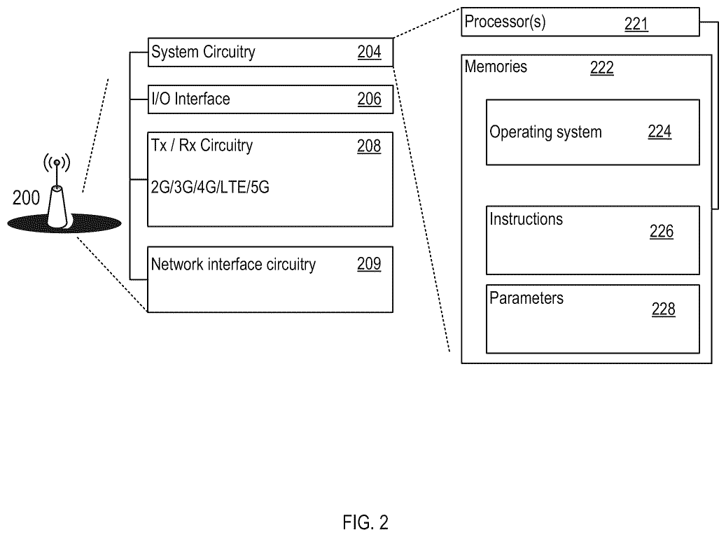

FIG. 2 shows an exemplary a radio access network or a wireless communication base station 200. The base station 200 may include radio transmitting/receiving (Tx/Rx) circuitry 208 to transmit/receive communication with one or more UEs, and/or one or more other base stations. The base station may also include network interface circuitry 209 to communicate the base station with other base stations and/or a core network, e.g., optical or wireline interconnects, Ethernet, and/or other data transmission mediums/protocols. The base station 200 may optionally include an input/output (I/O) interface 206 to communicate with an operator or the like.

The base station may also include system circuitry 204. System circuitry 204 may include processor(s) 221 and/or memory 222. Memory 222 may include an operating system 224, instructions 226, and parameters 228. Instructions 226 may be configured for the one or more of the processors 124 to perform the functions of the base station. The parameters 228 may include parameters to support execution of the instructions 226. For example, parameters may include network protocol settings, bandwidth parameters, radio frequency mapping assignments, and/or other parameters.

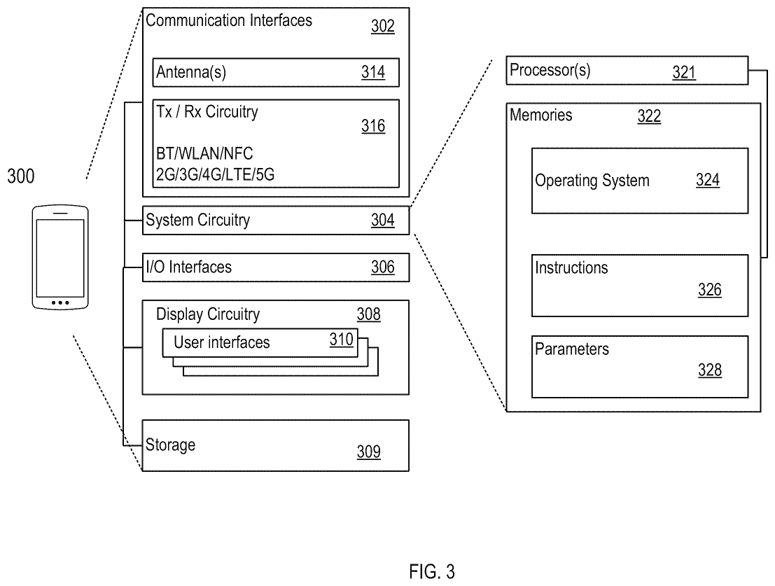

FIG. 3 shows an exemplary user equipment (UE) 300. The UE 300 may be a mobile device, for example, a smart phone or a mobile communication module disposed in a vehicle. The UE 300 may include communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/O interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), 5G or any future wireless communication standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G or other data that the UE 300 will send, or has received, through the communication interfaces 302. In various implementations, a system power for the UE 300 may be supplied by a power storage device, such as a battery or a transformer.

The present disclosure describes several embodiments of methods and devices for reporting in-device coexistence (IDC) interference, which may be implemented, partly or totally, on the wireless network base station and/or the user equipment described above in FIGS. 2 and 3.

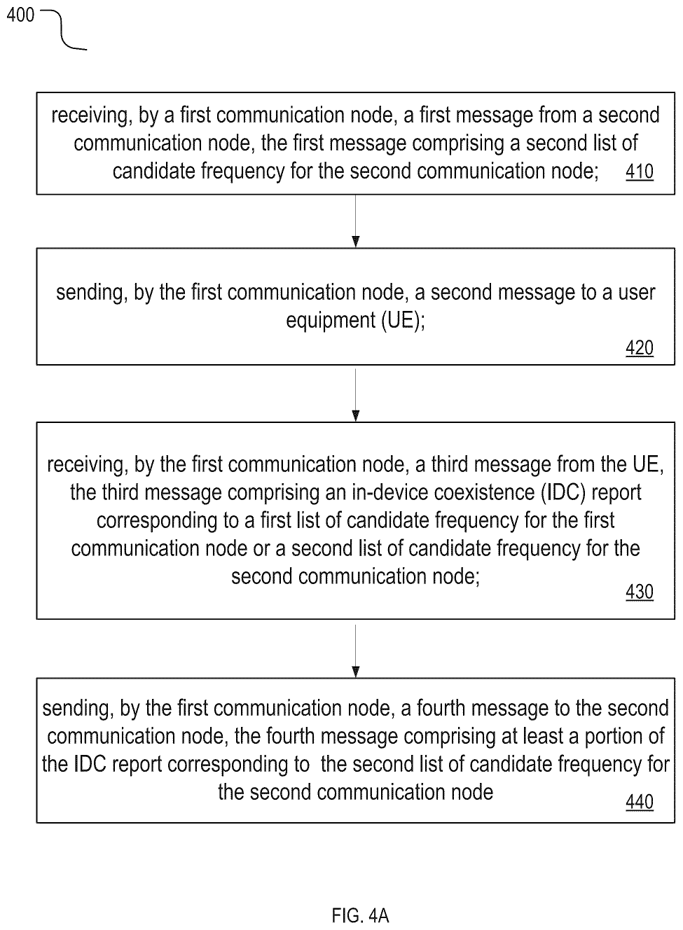

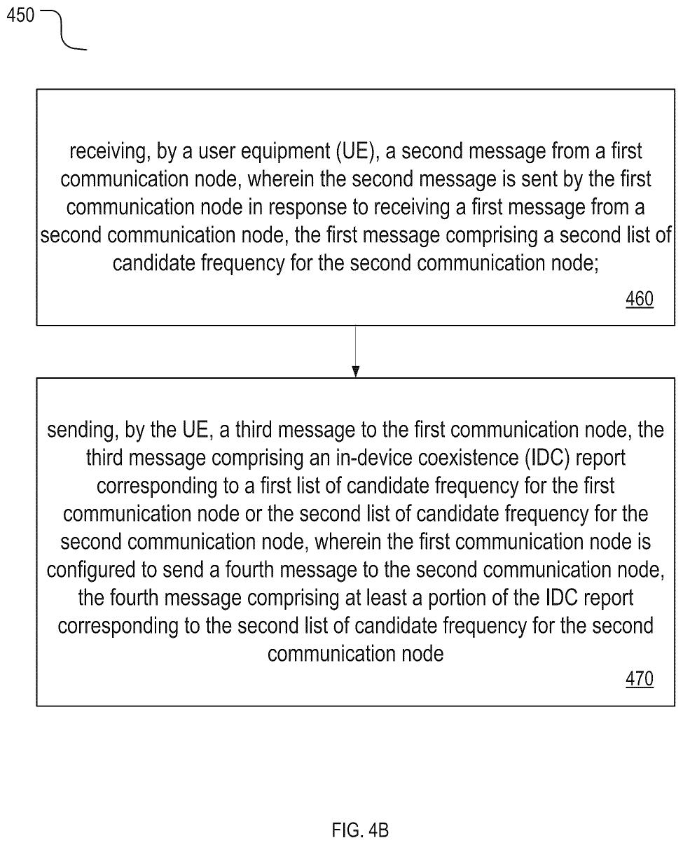

In various embodiments, FIG. 4A shows a flow diagram of a method 400 for wireless communication. The method 400 may include a portion or all of the following steps: step 410, receiving, by a first communication node, a first message from a second communication node, the first message comprising a second list of candidate frequency for the second communication node; step 420, sending, by the first communication node, a second message to a user equipment (UE); step 430, receiving, by the first communication node, a third message from the UE, the third message comprising an in-device coexistence (IDC) report corresponding to a first list of candidate frequency for the first communication node or a second list of candidate frequency for the second communication node; and/or step 440, sending, by the first communication node, a fourth message to the second communication node, the fourth message comprising at least a portion of the IDC report corresponding to the second list of candidate frequency for the second communication node.

In various embodiments, FIG. 4B shows a flow diagram of a method 450 for wireless communication. The method 450 may include a portion or all of the following steps: step 460, receiving, by a user equipment (UE), a second message from a first communication node, wherein the second message is sent by the first communication node in response to receiving a first message from a second communication node, the first message comprising a second list of candidate frequency for the second communication node; and/or step 470, sending, by the UE, a third message to the first communication node, the third message comprising an in-device coexistence (IDC) report corresponding to a first list of candidate frequency for the first communication node or the second list of candidate frequency for the second communication node, wherein the first communication node is configured to send a fourth message to the second communication node, the fourth message comprising at least a portion of the IDC report corresponding to the second list of candidate frequency for the second communication node.

In some implementations, in any one or any combination of the described implementations/embodiments, the first communication node comprises a master network node (MN), and/or the second communication node comprises a secondary network node (SN).

In some implementations, in any one or any combination of the described implementations/embodiments, the candidate frequency comprises a center frequency with a bandwidth or a frequency range.

In some implementations, in any one or any combination of the described implementations/embodiments, the second message comprises the first list of candidate frequency for the first communication node or the second list of candidate frequency for the second communication node; and/or the IDC report comprises at least one of the following: a first IDC report corresponding to the first list of candidate frequency for the first communication node, and/or a second IDC report corresponding to the second list of candidate frequency for the second communication node, and/or a third IDC report corresponding to at least one frequency combination from the first list and the second list; and/or the fourth message comprising the second IDC report or the third IDC report.

In some implementations, in any one or any combination of the described implementations/embodiments, the third IDC report corresponds to IDC situations under multi-radio access technology duel connectivity (MR-DC).

In some implementations, in any one or any combination of the described implementations/embodiments, the second message comprises a frequency list for the second communication node that comprises the second list of candidate frequency for the second communication node excluding any candidate frequency overlapping with the first list of candidate frequency for the first communication node.

In some implementations, in any one or any combination of the described implementations/embodiments, the first message comprises a container indicating the second list of candidate frequency for the second communication node; and/or the second message comprises the container.

In some implementations, in any one or any combination of the described implementations/embodiments, the container comprises a reconfiguration message; the third message comprises an uplink (UL) information transfer comprising the IDC report; and/or the fourth message comprises the UL information transfer.

In some implementations, in any one or any combination of the described implementations/embodiments, the first message comprises a container indicating the second list of candidate frequency for the second communication node; the second message comprises the container and the first list of candidate frequency for the first communication node; the third message comprises a UL information transfer and UE assistant information, wherein: the UL information transfer comprises the IDC report corresponding to the second list of candidate frequency for the second communication node, and/or the UE assistant information comprises a first IDC report corresponding to the first list of candidate frequency for the first communication node, and a second IDC report corresponding to at least one frequency combination from the first list and the second list; and/or the fourth message comprising the UL information transfer or the second IDC report.

In some implementations, in any one or any combination of the described implementations/embodiments, before the first communication node sends the second message to the UE, the first communication node sends a fifth message comprising the first list of candidate frequency for the first communication node and receives a first IDC report corresponding to the first list of candidate frequency for the first communication node; the first message comprises a container indicating the second list of candidate frequency for the second communication node; the second message comprises the container; the third message comprises a UL information transfer and UE assistant information, wherein: the UL information transfer comprises the IDC report corresponding to the second list of candidate frequency for the second communication node, and/or the UE assistant information comprises a second IDC report corresponding to at least one frequency combination from the first list and the second list; and/or the fourth message comprising the UL information transfer and the second IDC report.

In some implementations, in any one or any combination of the described implementations/embodiments, the second IDC report corresponds to IDC situations under MR-DC.

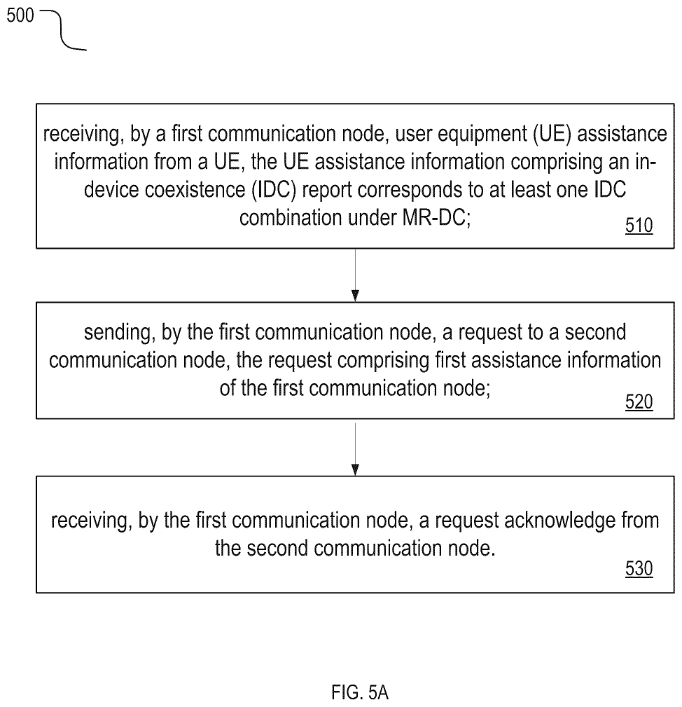

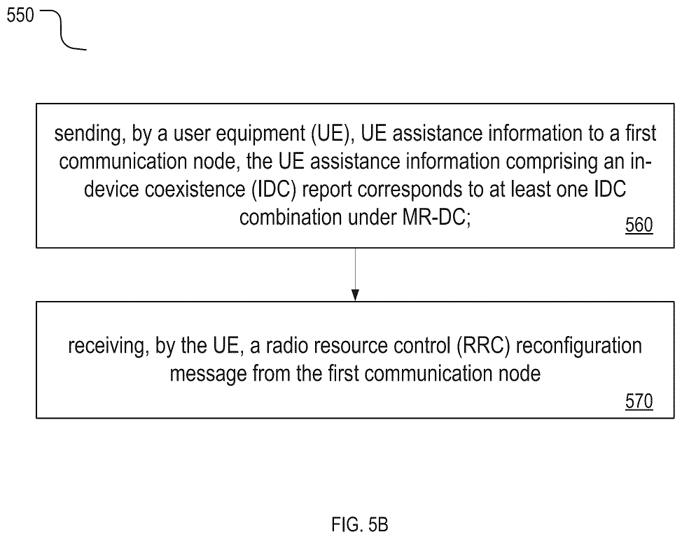

In various embodiments, FIG. 5A shows a flow diagram of a method 500 for wireless communication. The method 500 may include a portion or all of the following steps: step 510, receiving, by a first communication node, user equipment (UE) assistance information from a UE, the UE assistance information comprising an in-device coexistence (IDC) report corresponds to at least one IDC combination under MR-DC; step 520, sending, by the first communication node, a request to a second communication node, the request comprising first assistance information of the first communication node; and/or step 530, receiving, by the first communication node, a request acknowledge from the second communication node.

In various embodiments, FIG. 5B shows a flow diagram of a method 550 for wireless communication. The method 550 may include a portion or all of the following steps: step 560, sending, by a user equipment (UE), UE assistance information to a first communication node, the UE assistance information comprising an in-device coexistence (IDC) report corresponds to at least one IDC combination under MR-DC; and/or step 570, receiving, by the UE, a radio resource control (RRC) reconfiguration message from the first communication node.

In some implementations, in any one or any combination of the described implementations/embodiments, the request acknowledge comprises second assistance information of the second communication node.

In some implementations, in any one or any combination of the described implementations/embodiments, the first communication node comprises a master network node (MN), and/or the second communication node comprises a secondary network node (SN).

In some implementations, in any one or any combination of the described implementations/embodiments, each combination of the at least one IDC combination under MR-DC is represented by one index corresponding to a predefined list of IDC combinations of more than one frequency range.

In some implementations, in any one or any combination of the described implementations/embodiments, each combination of the at least one IDC combination under MR-DC is represented by more than one frequency range.

In some implementations, in any one or any combination of the described implementations/embodiments, the first assistant information indicates a first list of current serving frequency range by the first communication node that are included in the at least one IDC combination under the MR-DC.

In some implementations, in any one or any combination of the described implementations/embodiments, the first assistant information indicates a first list of current and potential serving frequency range by the first communication node that are included in the at least one IDC combination under the MR-DC.

In some implementations, in any one or any combination of the described implementations/embodiments, the second assistant information indicates a second list of current serving frequency range by the second communication node that are included in the at least one IDC combination under the MR-DC.

In some implementations, in any one or any combination of the described implementations/embodiments, the second assistant information indicates a second list of current and potential serving frequency range by the second communication node that are included in the at least one IDC combination under the MR-DC.

In some implementations, in any one or any combination of the described implementations/embodiments, the first assistant information comprises at least one of the following: one or more frequency band and one or more frequency bandwidth or range, one or more index corresponding to one or more predefined frequency range, one or more forbidden IDC index corresponding to the predefined list of IDC combinations, one or more available IDC index corresponding to the predefined list of IDC combinations, one or more forbidden frequency range for the second communication node, and/or one or more allowed frequency for the second communication node.

In some implementations, in any one or any combination of the described implementations/embodiments, the second assistant information comprises at least one of the following: one or more frequency band and one or more frequency bandwidth or range, one or more index corresponding to one or more predefined frequency range, one or more forbidden IDC index corresponding to the predefined list of IDC combinations, one or more available IDC index corresponding to the predefined list of IDC combinations, one or more forbidden frequency range for the second communication node, and/or one or more allowed frequency for the second communication node.

In some implementations, in any one or any combination of the described implementations/embodiments, a serving frequency range in the first list and the second list is represented by at least one of the following: a frequency range, or a physical resource block (PRB) range.

In some implementations, in any one or any combination of the described implementations/embodiments, the frequency range is represented by one of the following: a central frequency and a bandwidth, a starting frequency and an ending frequency, or a starting frequency and a bandwidth.

In some implementations, in any one or any combination of the described implementations/embodiments, a centralized unit (CU) of the first or the second communication node indicates frequency range restriction to a distributed unit (DU) of the first communication node; and/or the DU of the first communication node configures cell resources based on the frequency range restriction.

In some implementations, in any one or any combination of the described implementations/embodiments, the frequency range restriction is for a primary cell (Pcell) or a secondary cell (Scell).

In some implementations, in any one or any combination of the described implementations/embodiments, the frequency range restriction comprises at least one of the following: one or more frequency range, or one or more physical resource block (PRB) range.

In some implementations, in any one or any combination of the described implementations/embodiments, the frequency range is represented by one of the following: a central frequency and a bandwidth, a starting frequency and an ending frequency, or a starting frequency and a bandwidth.

### First Group of Embodiments

The present disclosure describes various non-limiting embodiments for addressing the issue of how the network configures the IDC reporting with MR-DC structure, for non-limiting examples, how the MN and the SN configure the IDC information. There may be several methods based on whether the SN can configure the IDC information independently: a first method (method 1) may include that only the MN can configure the IDC and the SN can not directly configure the IDC; and a second method (Method 2) may include that both the MN and the SN can configure the IDC.

For the first method (Method 1), the SN may indicate the candidate frequency list to the MN, and the MN may include both the candidate frequency list of the SN and MN and send them to the UE. There may be several methods of how to configure the candidate frequency list: one method (Method 1a) may include that the candidate frequencies of the SN and MN are configured to the UE separately; and another method (Method 1b) may include the candidate frequencies of the SN and MN are merged into one candidate list.

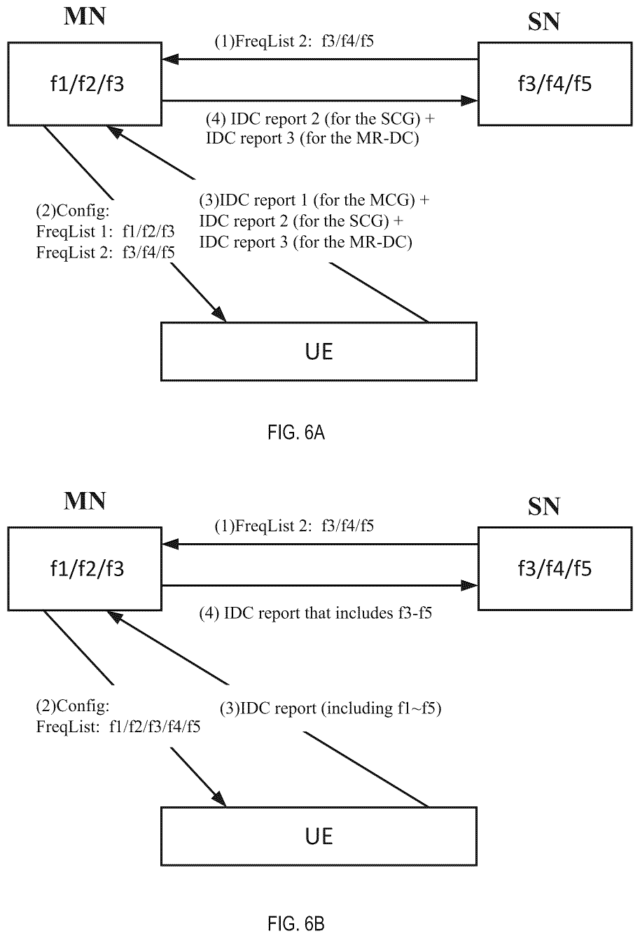

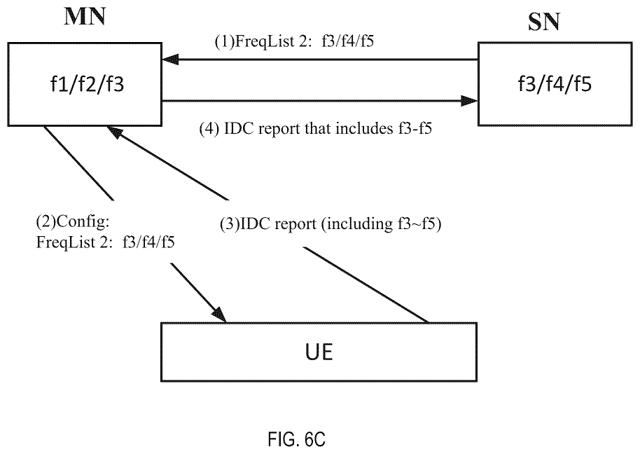

For the Method 1a, referring to FIG. 6A, the network may configure the IDC reporting with 2 candidate frequency list, e.g. a first list (FreqList 1) is for the MN and a second list (FreqList 2) is for the SN. The UE may report the IDC for the first frequency list and for the second frequency list separately (e.g. within 2 different parts, the first part is for the first list, while the second part is for the second list). The UE may also report the IDC that caused by the frequency combination from the first frequency list and the second frequency list as the third part. When the MN receives the IDC report by the UE, the MN may forward the second (e.g. for the second frequency list) and/or the third part to the SN.

Referring to FIG. 6A, an exemplary method is described wherein the MN configures IDC report with separate lists. The method includes a portion or all of the following steps.

Step 1: the SN indicates the candidate frequency list (or together with bandwidth/frequency range for each carrier) to the MN.

Step 2: the MN configures the IDC reporting with 2 candidate frequency lists (e.g. the first list is for the MN and the second list is for the SN, may send together with bandwidth/frequency range for each carrier) to the UE.

Step 3: the UE reports the IDC (including Frequency range information) that related to the carriers within the candidate frequency lists, which includes three part. The first part is for the first candidate frequency list (e.g. for the MCG), the second part is for the second frequency list (e.g. for the SCG), and the third part is for the frequency combination from the first frequency list and the second frequency list (e.g. MR-DC). In some implementations, the UE may report all of the IDC together, the MN to determine which IDCs are related to the SN, and the MN only sends to the SN the IDC that are related to the SN.

Step 4: The MN forwards the IDC that only related to the SN indicated candidate frequencies to the SN.

In some implementations, as an enhancement, during step 2, the MN may also delete the overlapped frequencies from the SN indicate list to avoid the overlap, for example, FreqList 1 includes f1/f2/f3 and Freqlist 2 includes f4/f5, wherein the f3 is deleted due to the fact that it has been included in the MN FreqList 1. This enhancement increase efficiency of the implementation. Without the enhancement, the MR-DC IDC among f3 and the f4/f5 would be report repeatedly in the IDC for the SCG and IDC for the MR-DC.

For the Method 1b, referring to FIG. 6B, a portion of the method may be similar to the legacy MR-DC IDC reporting procedure, and the difference is that the SN may also indicate the frequency ranges for each candidate frequency to the MN. When the UE reports the IDC to the MN, the MN may select the IDC that includes the SN candidate frequency and forwards it to the SN.

Referring to FIG. 6B, an exemplary method is described wherein the MN configures IDC report with a combined list. The method includes a portion or all of the following steps.

Step 1: the SN indicates the candidate frequency list (or together with bandwidth/frequency range for each carrier) to the MN.

Step 2: the MN indicates the candidate frequency list (e.g. include both the candidate frequency for the MN and SN) to the UE, (or together with bandwidth/frequency range for each carrier).

Step 3: the UE report the IDC (e.g., including Frequency range information) that related to the carriers within the candidate frequency list.

Step 4: The MN forwards the IDC that is only related to the SN indicated candidate frequencies to the SN. In some implementations, the MN may forward all of the UE reported IDC to the SN.

Referring to FIG. 6C, another exemplary method is described wherein the MN only configures IDC report only for the SN indicated/candidate frequency list. In some implementations, the MN may not include any candidate frequency from the MN side, and only the SN frequency is included and transmitted to the UE. The method includes a portion or all of the following steps.

Step 1: the SN indicates the candidate frequency list (or together with bandwidth/frequency range for each carrier) to the MN.

Step 2: the MN indicates the candidate frequency lists (e.g. for the SN only, may send together with bandwidth/frequency range for each carrier) to the UE.

Step 3: the UE reports the IDC (including frequency range information) that related to the carriers within the candidate frequency lists.

Step 4: the MN forward the IDC, which is only related to the SN indicated candidate frequencies, to the SN.

For the second method (Method 2), the SN may also configures the candidate frequency list independently from the MN side. There may be several methods of how the SN configures the IDC depending on whether a signaling radio bearer (SRB3) is involved: one method (Method 2a) may include that the SN configures the IDC without using the SRB3; and another method (Method 2b) may include that the SN configures the IDC using the SRB3. Being a type of Radio Bearer that carries signaling message (i.e, RRC or/and NAS message), SRB3 is for specific RRC messages when UE is in EN-DC, all using DCCH logical channel. In case of EN-DC, SRB3 may be configured for the transfer of some NR RRC messages between UE and secondary gNB via the NR radio interface.

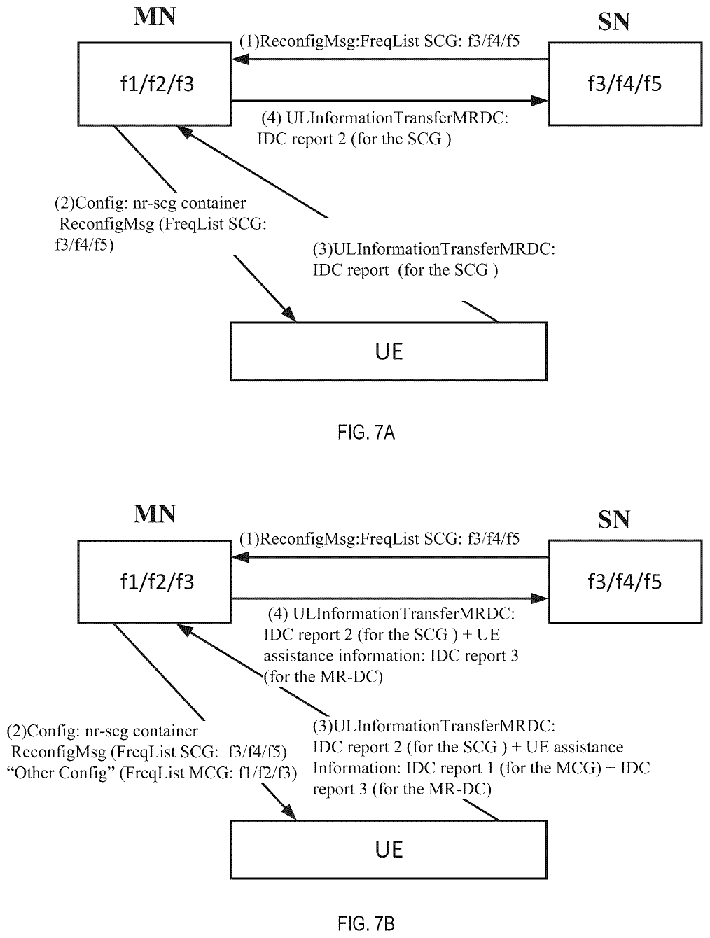

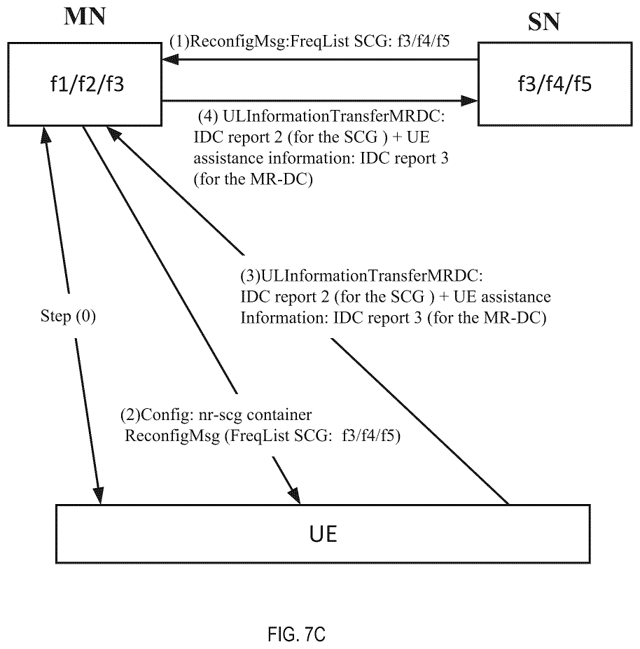

For the Method 2a, referring to FIG. 7A, the SN may configure the IDC independently. The SN candidate frequency list may be transparent to the MN (e.g. as a container). At the UE side, the UE may report the IDC caused by the SN side to the network, which is also transparent to the MN (e.g. with the ULInformationTransferMRDC message). Meanwhile, when the MN has also configured the IDC reporting, the UE may also report the IDC caused by the frequency combination from both the MN and SN within the UE Assistance Information (UAI) message, e.g., for the case that the MN also indicates to report the MR-DC IDC.

Referring to FIG. 7A, an exemplary method is described wherein the SN configures the IDC without SRB3, e.g., only SN has IDC configuration, and no IDC reporting was configured at the MN side. The method includes a portion or all of the following steps.

Step 1: the SN includes a ReconfigMessage to the MN, in which, it indicates the candidate frequency list (or together with frequency ranges for each carrier) to the UE.

Step 2: the MN sends a message to UE in which it includes a nr-scg container.

Step 3: the UE reports the IDC (including frequency range information) by UL information transfer for the SCG.

Step 4: the MN forwards the UL information transfer to the SN.

Referring to FIG. 7B, another exemplary method is described wherein the SN configure the IDC without SRB3, and the MN and the SN configure the IDC simultaneously. The method includes a portion or all of the following steps.

Step 1: the SN includes a ReconfigMessage to the MN, in which, it indicates the candidate frequency list (or together with bandwidth/frequency range for each carrier) to the UE.

Step 2: the MN sends a message to the UE in which it includes a nr-scg container, in which the freqList for the SCG is included. Furthermore, the MN also includes the candidate frequency list for the MCG in the “other config”.

Step 3: the UE reports the IDC (including frequency range information) by the UL information transfer for the SCG, meanwhile reports UE assistance Information to the MN for the MR-DC.

Step 4: the MN forwards the UL information transfer and/or the above UE assistance information (for the MR-DC) to the SN.

For a non-limiting example, the MN configures FreqList 1 including f1/f2/f3, and the SN configures Freqlist 2 including f3/f4/f5. The UE reports the IDC caused by Freqlist 2 with UL information transfer message for the SCG, meanwhile reports IDC caused by frequencies combination from the freqlist 1 and freqlist 2 for the MR-DC and IDC caused by Freqlist 1 for the MCG within UE assistance Information to the MN.

Referring to FIG. 7C, another exemplary method is described wherein the SN configures the IDC without SRB3, and the SN configures the IDC after the MN configuration. Compared to the exemplary method described above, the difference for the present exemplary method is that the MN configures the IDC first, and then the SN configures the IDC. The method includes a portion or all of the following steps.

Step 0: the MN configures the UE with MN candidate frequency list 1 (e.g. f1/f2/f3), and the UE report the IDC within frequency list 1 (e.g. f1/f2/f3).

Step 1: the SN includes a ReconfigMessage to the MN, in which, it indicates the candidate frequency list (or together with bandwidth/frequency range for each carrier) to the UE.

Step 2: the MN sends a message to UE in which it includes a nr-scg container.

Step 3: the UE report the IDC, e.g., including PRB or frequency range information, by UL information transfer for the SCG, meanwhile may report UE assistance Information to the MN for the MR-DC.

Step 4: the MN forwards the UL information transfer and/or the above UE assistance information to the SN.

For a non-limiting example, the MN configures FreqList 1 including f1/f2/f3, and the SN configures Freqlist 2 including f3/f4/f5. The UE reports the IDC caused by Freqlist 2 with UL information transfer message for the SCG, meanwhile reports IDC caused by frequencies combination from the freqlist 1 and freqlist 2 within UE assistance Information to the MN for the MR-DC, e.g. for the case that the MN also indicates to report the MR-DC IDC.

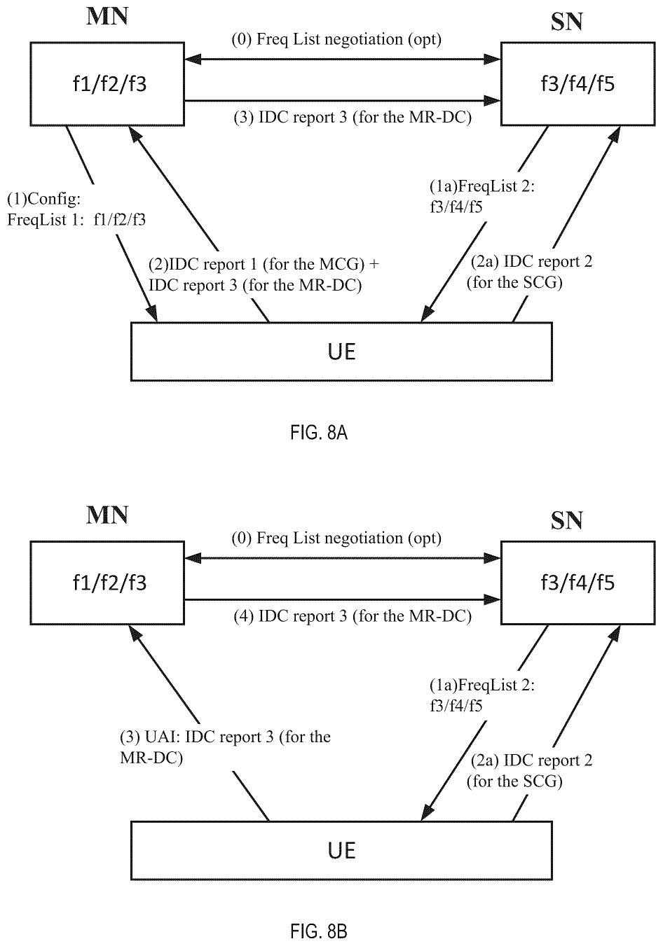

For the Method 2b, referring to FIG. 8A, the SN configures the IDC through the SRB3. At the UE side, the UE reports the IDC caused by the SN side to the network though the SRB3. Meanwhile, when the MN has also configured the IDC reporting, the UE may also report the IDC caused by the frequency combination from both the MN and SN, e.g. for the case that the MN also indicates to report the MR-DC IDC.

Referring to FIG. 8A, another exemplary method is described wherein the SN configures IDC with SRB3. The method includes a portion or all of the following steps.

Step 0: the MN and the SN negotiate the candidate frequency for each cell group (CG), for example, to determine which carrier shall be reported by the MN or the SN.

Step 1: the MN indicates the candidate frequency list, e.g., may send together with bandwidth/frequency range for each carrier, to the UE.

Step 2: the UE reports the IDC (including frequency range information, noted as IDC report 1) that related to the MN configured carriers within the candidate frequency lists to the MN. In some implementations, the UE may report the IDC for the MR-DC (noted as IDC report 3) together in this step when the UE has received the SN configuration or the UE has to report the IDC for the MR-DC (noted as IDC report 3) with separate message before the step 3.

Step 1a: the SN indicates the candidate frequency list, e.g., may send together with bandwidth/frequency range for each carrier, to the UE

Step 2a: the UE reports the IDC, which may include frequency range information (noted as IDC report 2), that related to the SN configured carriers within the candidate frequency lists to the SN.

Step 3: the MN forwards the IDC (noted as IDC report 3) that includes both MN and SN configured candidate frequencies to the SN.

Referring to FIG. 8B, another exemplary method is described wherein the SN configures IDC with SRB3, and only the SN has IDC configuration. The method includes a portion or all of the following steps.

Step 0: the MN and the SN negotiates the candidate frequency for each CG.

Step 1a: the SN indicates the candidate frequency list (may send together with bandwidth/frequency range for each carrier) to the UE.

Step 2a: the UE reports the IDC (including Frequency range information, noted as IDC report 2) that related to the SN configured carriers within the candidate frequency lists to the SN.

Step 3: the UE report the IDC for the MR-DC (noted as IDC report 3) to the MN node.

Step 4: the MN forwards the IDC (noted as IDC report 3) that includes both MN and SN configured candidate frequencies to the SN.

In some of the exemplary methods, it also means that the MR-DC IDC reporting may be triggered by the SCG IDC configuration, e.g. the MN configures the IDC first (e.g. candidate frequency list 1) then the SN configures the IDC (candidate frequency list 2). The UE may report the IDC that caused by at least 1 frequency from the candidate frequency list 1 and at least 1 frequency from the candidate frequency list 2, and/or the UE may report it with the condition that the MN indicates the MR-DC IDC reporting. Similarly, the MR-DC IDC reporting may be triggered by the MCG IDC configuration when the SCG has configured the IDC reporting before the MCG configuration.

### Second Group of Embodiments

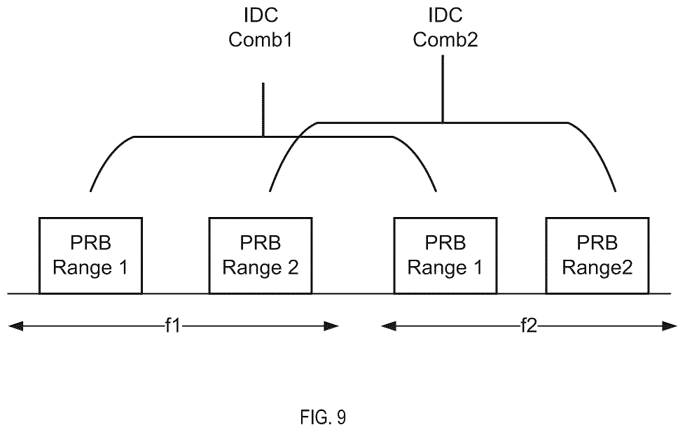

The present disclosure describes various non-limiting embodiments for addressing the issue of how the MN indicate the SN about the IDC interference information. In some implementations, there may be some issues/problems, for example, the UE may report the MR-DC IDC with frequency combinations; and as an enhancement, the UE may report more granular FDM information. Thus the MN and SN may also need to take these granular FDM information into consideration. For a non-limiting example, referring to FIG. 9, MN: F1: PRB (or Frequency) Range1, PRB (or Frequency) Range2; SN: F2: PRB (or Frequency) Range1, PRB (or Frequency) Range2; IDC 1: F1 PRB (or Frequency) Range1+F2 PRB (or Frequency) Range1; and IDC 2: F1 PRB (or Frequency) Range2+F2 PRB (or Frequency) Range2, which means when the UE Tx at F1 PRB (or Frequency) Range1+F2 PRB (or Frequency) Range1 simultaneously (or F1 PRB (or Frequency) Range2+F2 PRB (or Frequency) Range2 simultaneously), there may be IDC interference on the non-3gpp RAT. In other words, when the UE tx at the F1 PRB (or Frequency) Range1 and F2 PRB (or Frequency) Range2, there may be no IDC interference. FIG. 9 shows IDC combination (Comb) with PRB ranges. In some implementations, when the MN only indicates the SN that F1 is selected and doesn't indicate the PRB (or Frequency) Range information to the SN, the SN may take all frequency ranges on the F2 as invalid. This may lead to inefficient usage of frequency resources.

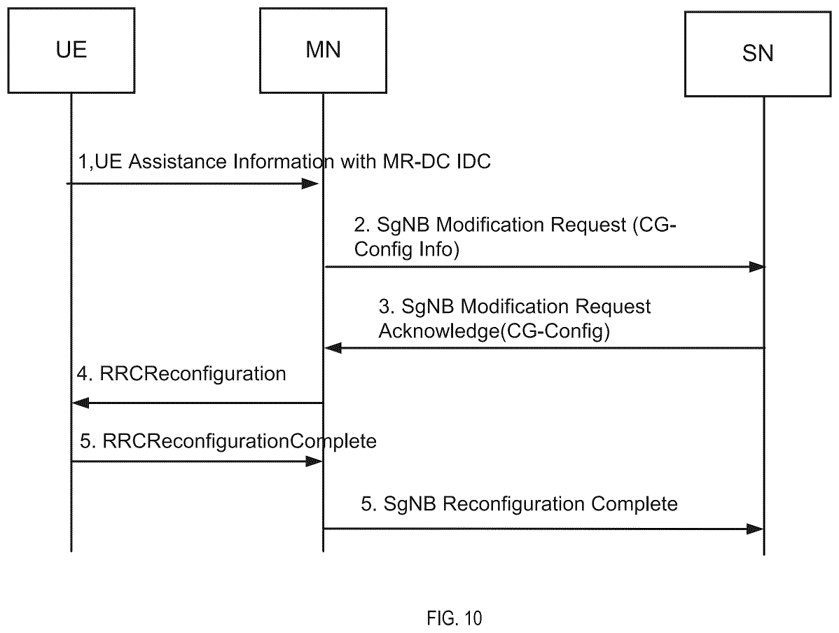

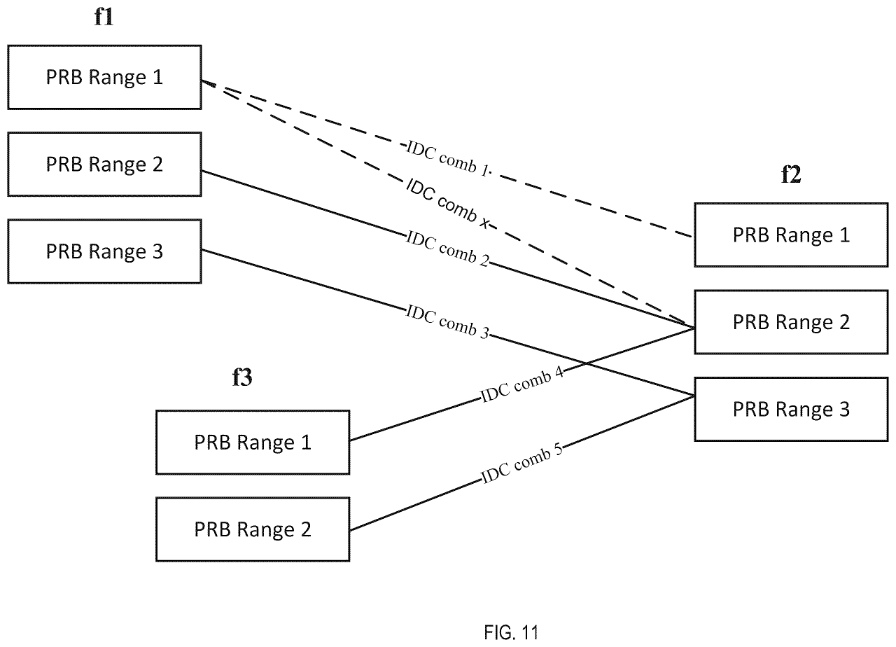

In various embodiments, as a general procedure for the MN-SN coordination, the MN may forward the IDC reported by the UE to the SN, and besides the UE reports IDC information, the MN may indicate some other assistance information to assist SN RB (or Frequency) Range selection. The assistance information to the SN may include one or more of the following: for one option (Option 1), the MN/SN only exchange the current serving PRB (or Frequency) Ranges that are included in MR-DC IDC combination; for another option (Option 2), the MN/SN exchange both the current serving PRB (or Frequency) Ranges and the potential serving PRB (or Frequency) Ranges that are included in MR-DC IDC combination. In some implementations, the MN/SN can exchange the related PRB (or Frequency) Ranges information explicitly or implicitly, e.g., by the IDC combination index or PRB (or Frequency) range index. For a non-limiting example, FIG. 10 shows a general procedure for the MN-SN coordination, which may include a portion or all of the following steps.

Step 1: the UE send the assistance information (including MR-DC IDC assistance Information) to the MN

Step 2: the MN determines the serving PRB (or Frequency) Ranges pool (or non-serving PRB (or Frequency) Ranges/potential serving PRB (or Frequency) Ranges) explicitly/implicitly to the SN (or secondary gNB (SgNB)) together with the MR-DC IDC assistance Information.

Step 3: the SN determines the available PRB (or Frequency) Ranges based on the information indicated by the MN (e.g. the serving frequency range information, the MR-DC IDC Comb list in the MR-DC assistance information, the SN may also indicate the serving PRB (or Frequency) Ranges (or non-serving PRB (or Frequency) Ranges/potential serving PRB (or Frequency) Ranges) explicitly/implicitly to the MN.

Step 4˜6: Finish the reconfiguration procedure, for example, in step 4, the MN sends a RRCReconfiguration to the UE; in step 5, the UE sends a

RRCReconfigurationComplete to the MN; and/or in step 6, the MN sends to the SN a SgNB Reconfiguration complete message.

Various embodiments include methods for performing UAI reporting in the above step 1. For the step 1, to reduce the signaling overhead, there may be several methods to report IMD IDC: a first method (Method 1) includes defining a list of PRB (or Frequency) Ranges first, and then the IDC comb is expressed by PRB (or Frequency) Range index; and/or a second method (Method 2) includes that the IDC comb is expressed by PRB (or Frequency) Range immediately/directly.

For the first method (Method 1), one non-limiting example may include ASN.1 for the IDC reporting with frequency (PRB) range as below.

```
MRDC-AssistanceInfo ::= SEQUENCE {
prbRangeListpool SEQUENCE (SIZE (1..maxNrofPRBrange)) OF prbRange
affectedCarrierFreqCombInfoListMRDC SEQUENCE (SIZE (1..maxNrofCombIDC)) OF affectedCarrierFreqCombMRDC, ...}
prbRange SEQUENCE {
            Centryfrequency ARFCN
            bandwidth Bandwidth}
affectedCarrierFreqCombMRDC SEQUENCE{
            affectedCarrierFreqCombEUTRA AffectedCarrierFreqCombEUTRA OPTIONAL,
            affectedCarrierFreqCombNREh AffectedCarrierFreqCombNREh}
AffectedCarrierFreqCombNREh SEQUENCE (SIZE (1..maxNrofNRComb)) OF prbRangeID
```

For the second method (Method 2), one non-limiting example may include ASN.1 for the IDC reporting with frequency (PRB) range as below.

```
MRDC-AssistanceInfo ::= SEQUENCE {
affectedCarrierFreqCombInfoListMRDC SEQUENCE (SIZE (1..maxNrofCombIDC)) OF affectedCarrierFreqCombMRDC, ...}
affectedCarrierFreqCombMRDC SEQUENCE{
          affectedCarrierFreqCombEUTRA AffectedCarrierFreqCombEUTRA OPTIONAL,
          affectedCarrierFreqCombNREh AffectedCarrierFreqCombNREh}
AffectedCarrierFreqCombNREh SEQUENCE (SIZE (1..maxNrofNRComb)) OF prbRange
prbRange SEQUENCE {
          Centryfrequency ARFCN
          bandwidth Bandwidth}
```

In some implementations: the above PRB range may be expressed by the below 3 ways: a first way (Option 1) Central frequency+Bandwidth of the actual affected frequency range; a second way (Option 2) Starting frequency+Ending frequency of the actual affected frequency range; and/or a third way (Option 2a): starting frequency+Bandwidth of the actual affected frequency range.

In the embodiments/implementation, one of the three above ways/options may be used merely as examples, any of the other ways/options to express the PRB range may be applicable similarly to any or all embodiments/implementation described in the present disclosure. For below description, Option 1 may be used as a non-limiting example.

Various embodiments include methods for exchanging additional assistance information in the above step 2 and/or 3. For the step 2/3, various methods may be performed to address one or all of the following issues/problems: a first issue/problem includes which additional information shall also be exchanged between the MN and SN; and/or a second issue/problem includes how to exchange these additional information between the MN and SN.

To address the first issue/problem, there may be several options: a first option (Option 1) includes that the UE only exchanges the current serving PRB (or Frequency) Ranges that are included in MR-DC IDC combination; and/or a second option (Option 2) includes that the UE exchanges both the current serving PRB (or Frequency) Ranges and the potential serving PRB (or Frequency) Ranges that are included in MR-DC IDC combination.

To address the first issue/problem, one method may include that the UE may exchange the related PRB (or Frequency) Ranges information explicitly or implicitly, e.g. by the IDC combination index or PRB (or Frequency) Range index.

FIG. 11 shows a non-limiting example for IDC with only serving frequency, wherein MN serving cell: f1 PRB (or Frequency) Range 1; SN serving cell: f2 PRB (or Frequency) Range 1; and the f3 is the non-serving frequency.

For the first option (Option 1), the UE may indicate the f1 PRB (or Frequency) Range 1 to the SN, and the SN may avoid f2 PRB (or Frequency) Range 1. In some implementations, for implicitly way: the UE may indicate MR-DC IDC comb Index (e.g. comb 1/x as in the FIG. 11) as forbidden MR-DC IDC comb Index to the SN (the SN would avoid f2 PRB (or Frequency) Range 1); or the UE may indicate available MR-DC IDC comb Index (2/3/4/5) and the MN may indicate the allowed PRB (or Frequency) Ranges for the SN, e.g. PRB (or Frequency) Range 3.

For a non-limiting example of the first option (Option 1), for explicit Way, the MN may send the following to the SN: F1+PRB (or Frequency) Range 1. For implicit way, a first solution may include indicating the corresponding PRB (or Frequency) Range index of “F1+PRB (or Frequency) Range 1” (for the above method 1), a second solution may include forbidden MR-DC IDC comb Index (1/x), a third solution may include available MR-DC IDC comb Index (2/3/4/5), and/or a fourth solution may include allowed (or forbidden) PRB (or Frequency) Ranges at the SN, e.g. PRB (or Frequency) Range 3 as allowable.

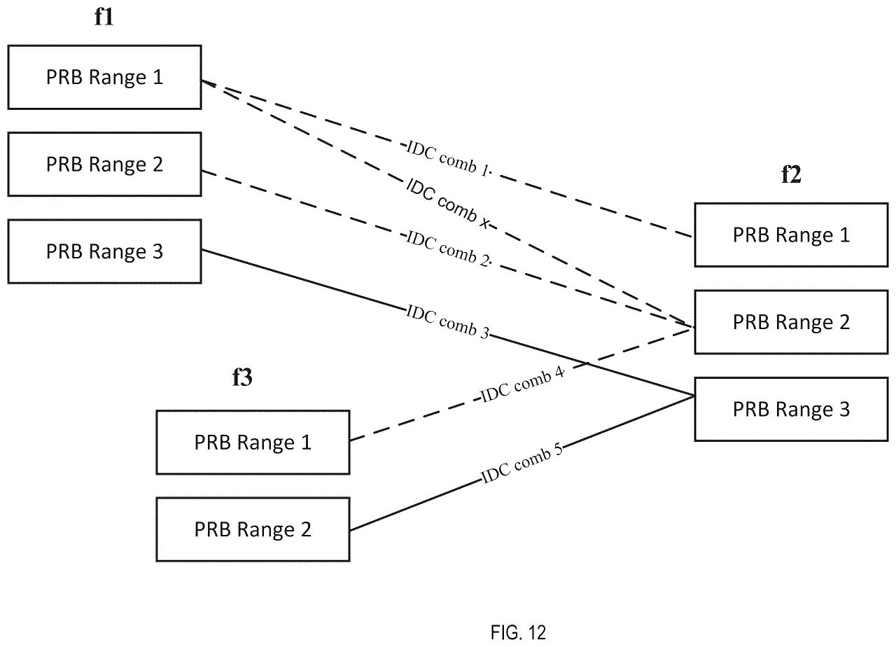

For the second option (Option 2), referring to FIG. 12, the UE may indicate f1 PRB (or Frequency) Range 1 and some other potential serving PRB (or Frequency) Ranges (for the potential handover e.g. PRB (or Frequency) Range 2 of f1 or PRB (or Frequency) Range 1 of f3. In some implementation for implicitly way, the UE may indicate MR-DC IDC comb Index (1, x, 2, and 4) as forbidden MR-DC IDC comb to the SN, and then the SN may avoid f2 PRB (or Frequency) Range 1/PRB (or Frequency) Range 2; or the UE may indicate available MR-DC IDC comb Index (3/5) or the MN may indicate the allowed PRB (or Frequency) Ranges for the SN, e.g. PRB (or Frequency) Range 3. FIG. 12 shows IDC with both serving frequency and non-serving frequency.

For a non-limiting example of the second option (Option 2), referring to FIG. 12, for explicit way, the MN sends to the SN the following: F1+PRB (or Frequency) Range 1, PRB (or Frequency) Range 2, and F3+PRB (or Frequency) Range 1. for implicit way, a first solution includes indicating the corresponding PRB (or Frequency) Range index of “F1+PRB (or Frequency) Range 1, PRB (or Frequency) Range 2, F3+PRB (or Frequency) Range 1” (for the above method 1); a second solution includes forbidden MR-DC IDC comb Index (1/2/4/x); a third solution includes available MR-DC IDC comb Index (3/5); a fourth solution includes allowed (or forbidden) PRB (or Frequency) Ranges at SN.

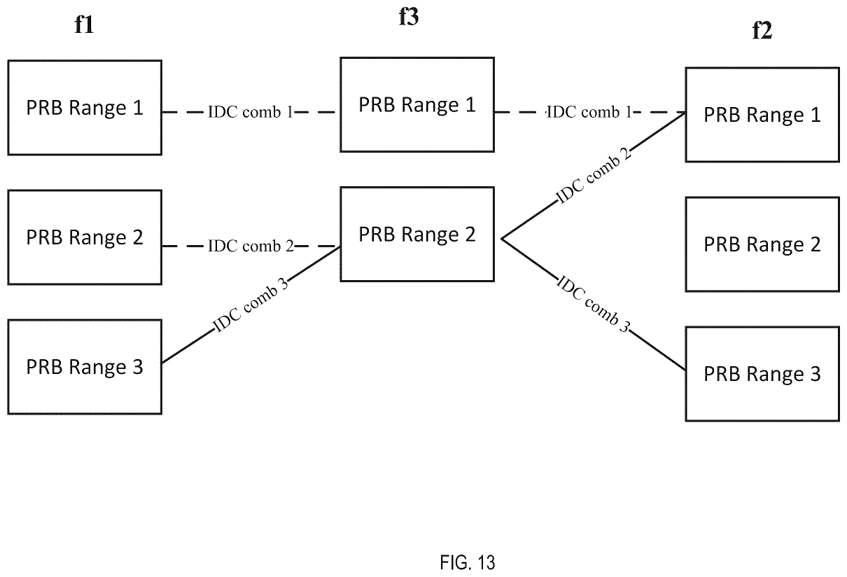

For another non-limiting example of the second option (Option 2), referring to FIG. 13, there are more than 2 carriers, e.g., for the IDC with more than 2 UL band entries, wherein IMD Comb 1: f1: PRB (or Frequency) Range 1+f2 PRB (or Frequency) Range 1+f3 PRB (or Frequency) Range 1; IMD Comb 2: f1: PRB (or Frequency) Range 2+f2 PRB (or Frequency) Range 2+f3 PRB (or Frequency) Range 1; and/or IMD Comb 3: f1: PRB (or Frequency) Range 3+f2 PRB (or Frequency) Range 2+f3 PRB (or Frequency) Range 3. In some implementations, at the MN side, the MN may configure the serving cell on the f1: PRB (or Frequency) Range 1/2 and f2 PRB (or Frequency) Range 1. For explicit way, the MN sends to the SN the following: F1+PRB (or Frequency) Range 1 PRB (or Frequency) Range 2, F3+PRB (or Frequency) Range 1. For implicit way, a first solution includes indicating the corresponding PRB (or Frequency) Range index of “F1+PRB (or Frequency) Range 1 PRB (or Frequency) Range 2, F3+PRB (or Frequency) Range 1” (for the above method 1); a second solution includes forbidden MR-DC IDC comb Index (1) for the MR-DC IDC comb 2, wherein the UE need to indicate the entry that has been included in the MN side, e.g. entry [0]=f1 PRB (or Frequency) Range 2, the MN may know that it shall avoid to use f2 PRB (or Frequency) Range 2+f3 PRB (or Frequency) Range 1 simultaneously; a third solution includes available MR-DC IDC comb Index (3); and/or a fourth solution includes allowed (or forbidden) PRB (or Frequency) Ranges at the SN.

In the above examples, the SN would determine the affected (e.g., available/forbidden) MR-IDC comb based on the index and the MR-DC IDC assistance information (e.g. MRDC-AssistanceInfo as defined above, which would also be transferred to the SN node by the MN).

Various embodiments may include methods for F1 interface impact with the Frequency range, wherein a CU may indicate the Frequency range restriction information to a DU, and the DU may take the Frequency range restriction information into consideration when configuring the cell resources to the UE.

Table 1 shows a non-limiting example for adding frequency range limitation to the UE CONTEXT SETUP/MODIFICATION REQUEST.

TABLE 1
Adding frequency range limitation

| IE/Group Name | Presence | IE type and reference | Semantics description |
|---|---|---|---|
| Message Type | M | 9.3.1.1 | |
| gNB-CU UE F1AP ID | M | 9.3.1.4 | |
| gNB-DU UE F1AP ID | O | 9.3.1.5 | |
| SpCell ID | M | NR CGI | Special Cell as defined in TS 38.321 [16]. For |
| | | 9.3.1.12 | handover case, this IE is considered as target cell. |
| Frequency range | | | Indicate the Frequency range restriction to the |
| limitation | | | SPcell |
| ServCellIndex | M | INTEGER (0 . . . 31, . . . ) | |
| SpCell UL Configured | O | Cell UL Configured | |
| | | 9.3.1.33 | |
| | | (ENUMERATED (none, | |
| | | UL, SUL, UL and | |
| | | SUL, . . . )) | |
| CU to DU RRC | M | 9.3.1.25 | |
| Information | | | |
| Candidate SpCell List | | | |
| >Candidate SpCell | | | |
| Item IEs | | | |
| >>Candidate SpCell | M | NR CGI | Special Cell as defined in TS 38.321 [16] |
| ID | | 9.3.1.12 | |
| DRX Cycle | O | DRX Cycle | |
| | | 9.3.1.24 | |
| Resource Coordination | O | OCTET STRING | Includes the MeNB Resource Coordination |
| Transfer Container | | | Information IE as defined in subclause 9.2.116 of |
| | | | TS 36.423 [9] for EN-DC case or MR-DC |
| | | | Resource Coordination Information IE as defined |
| | | | in TS 38.423 [28] for NGEN-DC and NE-DC |
| | | | cases. |
| SCell To Be Setup List | | | |
| >SCell to Be Setup | | | |
| Item IEs | | | |
| >>SCell ID | M | NR CGI | SCell Identifier in gNB |
| | | 9.3.1.12 | |
| >>SCellIndex | M | INTEGER (1 . . . 31) | |
| >>Frequency range | | | Indicate the Frequency range restriction to the |
| limitation | | | Scell |
| >>SCell UL | O | Cell UL Configured | |
| Configured | | 9.3.1.33 | |
| >servingCellMO | O | INTEGER (1 . . . 64) | |

In some implementations, each of the “frequency range limitation” in Table 1 may include one or more frequency ranges, and the frequency range may be represented by at least one of the following: a central frequency and a bandwidth, or a starting frequency and an ending frequency, or a starting frequency and a bandwidth.

The present disclosure describes methods, apparatus, and computer-readable medium for wireless communication. The present disclosure addressed the issues with IDC interference reporting. The methods, devices, and computer-readable medium described in the present disclosure may facilitate the performance of wireless communication by reporting IDC interference, thus improving efficiency and overall performance. The methods, devices, and computer-readable medium described in the present disclosure may improves the overall efficiency of the wireless communication systems.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method for wireless communication, comprising:
receiving, by a first communication node, a first message from a second communication node, the first message comprising a second list of candidate frequency for the second communication node;
sending, by the first communication node, a second message to a user equipment (UE);
receiving, by the first communication node, a third message from the UE, the third message comprising an in-device coexistence (IDC) report corresponding to a first list of candidate frequency for the first communication node or a second list of candidate frequency for the second communication node; and
sending, by the first communication node, a fourth message to the second communication node, the fourth message comprising at least a portion of the IDC report corresponding to the second list of candidate frequency for the second communication node.

2. A method for wireless communication, comprising:
receiving, by a user equipment (UE), a second message from a first communication node, wherein the second message is sent by the first communication node in response to receiving a first message from a second communication node, the first message comprising a second list of candidate frequency for the second communication node; and
sending, by the UE, a third message to the first communication node, the third message comprising an in-device coexistence (IDC) report corresponding to a first list of candidate frequency for the first communication node or the second list of candidate frequency for the second communication node, wherein the first communication node is configured to send a fourth message to the second communication node, the fourth message comprising at least a portion of the IDC report corresponding to the second list of candidate frequency for the second communication node.

3. The method according to claim 1, wherein:
the first communication node comprises a master network node (MN), and
the second communication node comprises a secondary network node (SN).

4. The method according to claim 1, wherein:
the candidate frequency comprises a center frequency with a bandwidth or a frequency range.

5. The method according to claim 1, wherein:
the second message comprises the first list of candidate frequency for the first communication node or the second list of candidate frequency for the second communication node;
the IDC report comprises at least one of the following:
a first IDC report corresponding to the first list of candidate frequency for the first communication node,
a second IDC report corresponding to the second list of candidate frequency for the second communication node, or
a third IDC report corresponding to at least one frequency combination from the first list and the second list; and
the fourth message comprising the second IDC report or the third IDC report.

6. The method according to claim 5, wherein:
the third IDC report corresponds to IDC situations under multi-radio access technology duel connectivity (MR-DC).

7. (canceled)

8. The method according to claim 1, wherein:
the first message comprises a container indicating the second list of candidate frequency for the second communication node; and
the second message comprises the container.

9. (canceled)

10. The method according to claim 1, wherein:
the first message comprises a container indicating the second list of candidate frequency for the second communication node;
the second message comprises the container and the first list of candidate frequency for the first communication node;
the third message comprises a UL information transfer and UE assistant information, wherein:
the UL information transfer comprises the IDC report corresponding to the second list of candidate frequency for the second communication node, and
the UE assistant information comprises a first IDC report corresponding to the first list of candidate frequency for the first communication node, and a second IDC report corresponding to at least one frequency combination from the first list and the second list; and
the fourth message comprising the UL information transfer or the second IDC report.

11. The method according to claim 1, wherein:
before the first communication node sends the second message to the UE, the first communication node sends a fifth message comprising the first list of candidate frequency for the first communication node and receives a first IDC report corresponding to the first list of candidate frequency for the first communication node;
the first message comprises a container indicating the second list of candidate frequency for the second communication node;
the second message comprises the container;
the third message comprises a UL information transfer and UE assistant information, wherein:
the UL information transfer comprises the IDC report corresponding to the second list of candidate frequency for the second communication node, and
the UE assistant information comprises a second IDC report corresponding to at least one frequency combination from the first list and the second list; and
the fourth message comprising the UL information transfer and the second IDC report.

12-32. (canceled)

33. The method according to claim 2, wherein:
the first communication node comprises a master network node (MN), and
the second communication node comprises a secondary network node (SN).

34. The method according to claim 2, wherein:
the candidate frequency comprises a center frequency with a bandwidth or a frequency range.

35. The method according to claim 2, wherein:
the second message comprises the first list of candidate frequency for the first communication node or the second list of candidate frequency for the second communication node;
the IDC report comprises at least one of the following:
a first IDC report corresponding to the first list of candidate frequency for the first communication node,
a second IDC report corresponding to the second list of candidate frequency for the second communication node, or
a third IDC report corresponding to at least one frequency combination from the first list and the second list; and
the fourth message comprising the second IDC report or the third IDC report.

36. The method according to claim 35, wherein:
the third IDC report corresponds to IDC situations under multi-radio access technology duel connectivity (MR-DC).

37. The method according to claim 2, wherein:
the first message comprises a container indicating the second list of candidate frequency for the second communication node; and
the second message comprises the container.

38. The method according to claim 2, wherein:
the first message comprises a container indicating the second list of candidate frequency for the second communication node;
the second message comprises the container and the first list of candidate frequency for the first communication node;
the third message comprises a UL information transfer and UE assistant information, wherein:
the UL information transfer comprises the IDC report corresponding to the second list of candidate frequency for the second communication node, and
the UE assistant information comprises a first IDC report corresponding to the first list of candidate frequency for the first communication node, and a second IDC report corresponding to at least one frequency combination from the first list and the second list; and
the fourth message comprising the UL information transfer or the second IDC report.

39. The method according to claim 2, wherein:
before the first communication node sends the second message to the UE, the first communication node sends a fifth message comprising the first list of candidate frequency for the first communication node and receives a first IDC report corresponding to the first list of candidate frequency for the first communication node;
the first message comprises a container indicating the second list of candidate frequency for the second communication node;
the second message comprises the container;
the third message comprises a UL information transfer and UE assistant information, wherein:
the UL information transfer comprises the IDC report corresponding to the second list of candidate frequency for the second communication node, and
the UE assistant information comprises a second IDC report corresponding to at least one frequency combination from the first list and the second list; and
the fourth message comprising the UL information transfer and the second IDC report.

40. A first communication node comprising:
a memory storing instructions; and
at least one processor in communication with the memory, wherein, when the at least one processor executes the instructions, the at least one processor is configured to cause the first communication node to perform:
receiving a first message from a second communication node, the first message comprising a second list of candidate frequency for the second communication node;
sending a second message to a user equipment (UE);
receiving a third message from the UE, the third message comprising an in-device coexistence (IDC) report corresponding to a first list of candidate frequency for the first communication node or a second list of candidate frequency for the second communication node; and
sending a fourth message to the second communication node, the fourth message comprising at least a portion of the IDC report corresponding to the second list of candidate frequency for the second communication node.

41. The first communication node according to claim 40, wherein:
the second message comprises the first list of candidate frequency for the first communication node or the second list of candidate frequency for the second communication node;
the IDC report comprises at least one of the following:
a first IDC report corresponding to the first list of candidate frequency for the first communication node,
a second IDC report corresponding to the second list of candidate frequency for the second communication node, or
a third IDC report corresponding to at least one frequency combination from the first list and the second list; and
the fourth message comprising the second IDC report or the third IDC report.

42. An apparatus comprising:
a memory storing instructions; and
at least one processor in communication with the memory, wherein, when the at least one processor executes the instructions, the at least one processor is configured to cause the apparatus to perform:
receiving a second message from a first communication node, wherein the second message is sent by the first communication node in response to receiving a first message from a second communication node, the first message comprising a second list of candidate frequency for the second communication node; and
sending a third message to the first communication node, the third message comprising an in-device coexistence (IDC) report corresponding to a first list of candidate frequency for the first communication node or the second list of candidate frequency for the second communication node, wherein the first communication node is configured to send a fourth message to the second communication node, the fourth message comprising at least a portion of the IDC report corresponding to the second list of candidate frequency for the second communication node.

43. The apparatus according to claim 42, wherein:
the second message comprises the first list of candidate frequency for the first communication node or the second list of candidate frequency for the second communication node;
the IDC report comprises at least one of the following:
a first IDC report corresponding to the first list of candidate frequency for the first communication node,
a second IDC report corresponding to the second list of candidate frequency for the second communication node, or
a third IDC report corresponding to at least one frequency combination from the first list and the second list; and
the fourth message comprising the second IDC report or the third IDC report.
